(19) United States
(12) Patent Application Publication
(10) Pub. No.: US 2019/0143764 A1
(43) Pub. Date: May 16, 2019

(54) PNEUMATIC TIRE WITH NOISE DAMPER

(71) Applicant: Triangle Tyre Co. Ltd., Weihai (CN)

(72) Inventors: Ramendra Nath Majumdar, Hudson, OH (US); Edward Montgomery, North Canton, OH (US); Wang Dapeng, Weihai City (CN); Zhang Tao, Weihai CIty (CN)

(21) Appl. No.: 15/809,193

(22) Filed: Nov. 10, 2017

(51) Int. Cl. B60C 19/00; B29D 30/06

(52) U.S. Cl. CPC B60C 19/002; B29K 2675/00; B29D 30/0681

(57) ABSTRACT

A tire comprising a circumferential tread having an outer tread surface and an inner innerliner surface; at least two spaced-apart beads; sidewall portions extending between the tread and the beads; and a belt-like foam noise damper having first and second terminal ends, wherein the noise damper lines said innerliner surface; wherein the noise damper is adhesively secured to the innerliner surface, and wherein the terminal ends of the noise damper are cut at an angle of less than 90 degrees, overlap each other, and the overlapped second terminal end of the foam is joined to the first terminal end by the adhesive present underneath the second terminal end.

### BACKGROUND OF THE INVENTION

The present invention is directed to a foam noise damper, for use in tires to dampen sound, where the terminal ends of the noise damper are such as to allow it to be installed without the need to bind the terminal ends of the noise damper by applying an adhesive between the two ends of the foam.

It is known in the art that all carcasses of pneumatic green tires are built as a series of layers of flexible high modulus cords encased in a low modulus rubber; the cords in each layer are oriented in a chosen path or direction and substantially equally spaced and parallel. Before curing, the tire is often shaped by blowing air inside, and at that time substantial expansion occurs. Components with lower low strain modulus expand easier than components with higher low strain modulus. The tire, whether belted radial ply or bias ply, is cured in a curing press using a curing bladder, which forces expansion of the tire.

A noise damper precursor can be placed which will form a noise damper during tire cure. In that case the noise damper precursor will expand with the carcass. Noise damper precursor can also be applied to green (uncured) tire and in that case no expansion of noise damper precursor will take place. (See, for example U.S. Pat. No. 7,694,707 to Agostini and Leyssens).

When the carcass is cured with a noise damper precursor in it, as it usually is in a tubeless tire, the noise damper precursor may further expand with the carcass, which is forced against the indentations in the curing mold to form the tread, and all components are co-cured so as to provide a substantially cohesive bond between one and another. A noise damper for a pneumatic tire, when it is built in, is typically formed from a compound containing a major proportion by weight of a halo butyl rubber.

No prior art exists where noise damper is placed before tire cure on tire building drum and the noise damper expands with the expansion of the tire. However, prior art exists where noise damper is attached after green (uncured) tire expansion and then curing the tire (See for example Polymers & Tyre Asia, June/July 2012, p. 48; or Sandstrom, Majumdar, Sundkvist, Bormann, Pan, “Method for making pneumatic tire with foam noise damper”; EP 2397314 B1, May 29, 2013).

The use of foam with rectangular longitudinal cross-section is very common where the two ends are cut at an angle of 90 degrees and the ends of the foam are joined in a butt joint by an adhesive. The foam length must be very close to the inner circumference of the tire to join the ends with a separate application of adhesive with negligible margin of error, which makes its application very cumbersome.

The foam is a sponge like multi-cellular material, which may be provided with a water-impermeable outer coating to prevent water from infiltrating into the sponge like multi-cellular material. Typically, the foam has a belt-shape, a rectangular cross-section, and a flat surface. Foam with uneven surface or a patterned surface facing the cavity has also been employed. See, for example, U.S. Pat. No. 6,726,289 to Yukawa et al., which shows irregular surfaces, the teaching of which is incorporated herein by reference. Typically, the foam is adhered to noise damper using a pressure-sensitive adhesive, for example, a transfer adhesive or a double-sided adhesive tape. Usually the tire innerliner should be free of mold release composition for good bonding to the foam. Some silicone adhesives can be applied without cleaning the mold release composition. In many cases, the terminal ends of the foam are joined by an adhesive in an end-to-end butt joint by applying adhesive to the entire splice surface, or to save adhesive, by partially covering the splice surface. Other means of placing foam inside tire without joining the terminal ends of the foam include the use of a coupling member. See, for example, U.S. Pat. No. 7,556,075 to A. Tanno, which teaches multiple pieces of noise dampers in a Low Noise Pneumatic Tire, as well as a variety of uneven noise damper surfaces for noise reduction.

U.S. Pat. No. 7,669,628 to N. Yukawa teaches a pneumatic tire having a noise damper, where the noise damper is fixed to the inner surface, using a double-sided adhesive tape, and the noise damper has a substantially constant cross-sectional shape along the entire circumferential length. Yukawa teaches an exception for the end portions of the damper, where in the case where the ends of the damper are not connected to each other, it is preferable that the end portions are tapered to prevent friction between the ends when the ends of the damper are not connected to each other using a glue or other means.

### SUMMARY OF THE INVENTION

The present invention is to a noise damper for a tire in which a tire carcass having a circumferential tread, at least one ply, at least two spaced-apart beads, and sidewall portions extending between the tread and the beads, has an adhesively secured noise damper which lines an inner surface of the tire and the terminal ends are cut at an angle of less than 90 degrees, overlap each other, and the overlapping terminal end of the foam is coated with an adhesive and the adhesive will join the overlapped terminal to the other terminal end.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a bead-to-bead cross-sectional view of a tire showing a foam noise damper installed in a tire; and

FIG. 2 is a longitudinal cross-sectional side view of a foam noise damper in accordance with the present invention having tapered ends;

FIG. 2A is an enlarged view of FIG. 2, which further includes an adhesive layer and adhesive protective layer;

FIG. 3 is a longitudinal cross-sectional side view of a foam noise damper where one terminal end overlaps the other terminal end and they are joined by an adhesive applied to the overlapping terminal end underneath the foam; and

FIGS. 4-6 are annular cross-sectional views through the center of the tread of alternative applications of the noise damper in accordance with the present invention.

### DETAILED DESCRIPTION OF THE INVENTION

The present invention is to a foam noise damper for a tire in which a tire carcass having a circumferential tread, at least one ply, at least two spaced-apart beads, and sidewall portions extending between the tread and the beads, has an adhesively secured noise damper which lines an inner surface of the tire and the terminal ends are cut at an angle of less than 90 degrees, and overlap each other.

The present invention uses a belt-like foam where the two ends of foam are such that they are cut at an angle and will overlap. The length of the foam is longer than the internal circumference of the tire in which it is installed. So, when the longer side is coated with adhesive or used with an adhesive tape to adhere it to the tire, the splice will physically overlap. In doing so, the sound absorption achieved by the present invention, for example, was similar to that of foam where spliced ends were the exact length to cover the inner surface of a tire and were joined directly by a separate application of an adhesive.

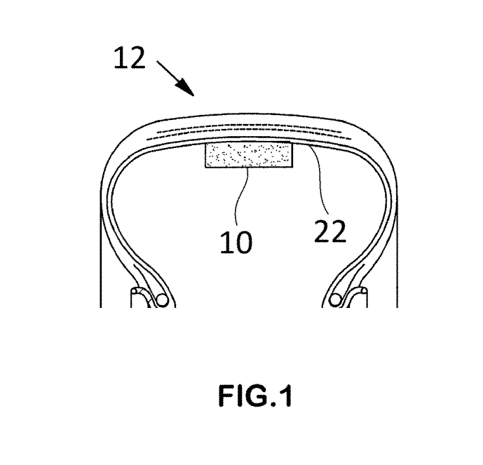

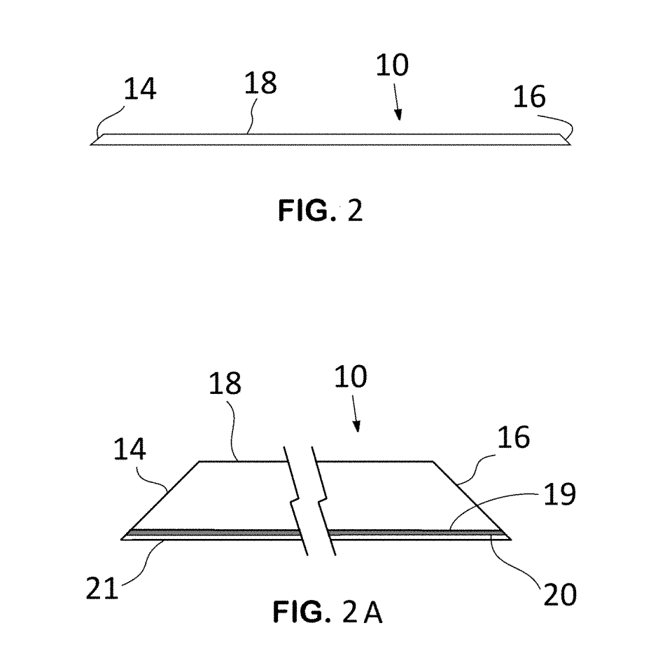

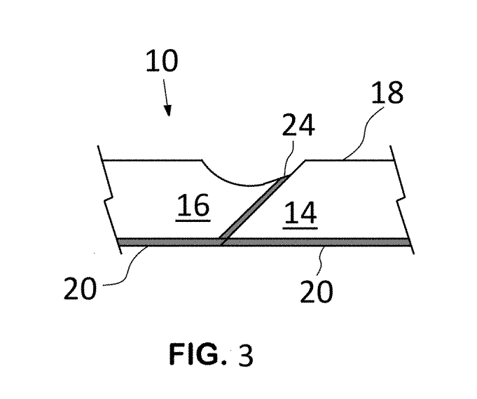

The foam 10 has a generally rectangular shape when taken in a cross-sectional view when installed in a tire 12 as shown in FIG. 1. But, the inner surface 18 of the foam can have a shaped surface that is wavy or has bumps as is known in the art. The cut ends 14, 16 of the foam 10 when taken along a longitudinal cross-sectional view, as shown in FIGS. 2 and 2A, describes a trapezoidal shape, wherein the length of the inner surface 18 is shorter than the length of the outer surface 19. An adhesive 20 is present in the longer side 19 of the foam when cut/died out from a roll where one side is coated with a pressure-sensitive adhesive. Alternatively, an adhesive can be applied to adhere the foam to the inner surface or innerliner 22 of the tire. The adhesive 20 can have an optional paper cover/backing 21 that can be removed prior to applying the foam 10 to the inner surface of the tire.

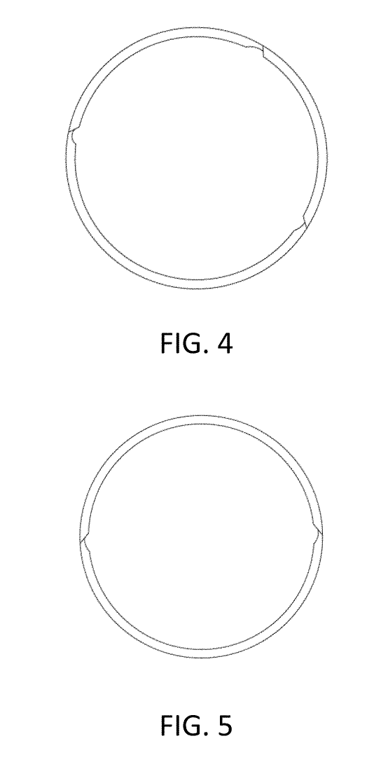

Since the length of the foam is longer than the inner circumference of the tire, the terminal ends of the foam can overlap. A first terminal end 14 of the foam 10 can be adhered to the inside of the tire with the result that the second terminal end 16 will overlap the first terminal end 14, as shown in FIG. 3. The overlapping terminal end 16 will then be adhesively bonded to terminal end 14 with the adhesive 24 already present underneath the terminal end 16. (In this case, the adhesive of 24 is the same as the adhesive of 20).

An alternative embodiment involves applying the adhesive 20 to the foam 10, placing the foam into the tire. Another embodiment involves applying the adhesive 20 to the inside of the tire, placing the foam into the tire, then applying an adhesive 24 to the splice between the terminal ends 14, 16.

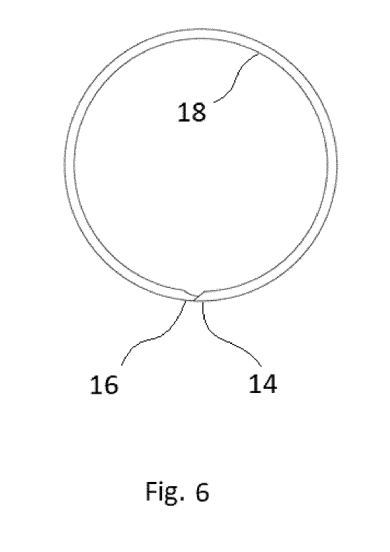

As is shown in FIGS. 4-6, the foam can be installed as a single piece (FIG. 6) or as multiple pieces. FIG. 4 shows an installation as three pieces, while FIG. 5 shows two pieces.

The angle of cut of the terminal end of the foam should be less than 90° and preferably between 65° and 5°, with 45° to 10° also being preferred. The angle on each end can be the same or different. The angles of the terminal ends are cut to form the foam into a trapezoidal shape.

The terminal end can be described as a right-angled triangle with angle being defined by the hypotenuse and the base. For example, for a foam having a thickness of 25 mm, at 45°, the base is 25 mm and hypotenuse is 35 mm, which would be a 100% overlap of the angled cut. At a 15° angle, the base would be 93 mm and the hypotenuse would be 96 mm. The overlap will be at least 1 mm up to 100 mm, with a preferred range of 48-96 mm representing respectively about 50-100% overlap.

The lower the angle, the more the margin of error in cutting the foam is allowed. When the angle is 45 degrees, for a foam thickness of 25 mm, the margin of error allowed is 18 mm, assuming a 50-100% overlap of the angled cut. When the angle is 15 degrees, the margin of error allowed is 58 mm, assuming 50-100% overlap. These splices assume a rectangular cross section, but other shapes can also be used for foams as are known in the art. The formula used is as follows:

25 mm/×=tan 15=0.2679

Thus, x=93.3 mm, the hypotenuse is 96 mm, and ½ of the hypotenuse would be 58 mm.

For a greater margin of error, a lower degree cut is preferred. However, if the angle is too small, such as 5°, then a part of the foam will be very thin and have increased chances of breaking/ripping. The preferred acoustic foam is polyether polyurethane. The foam receives a water-repellent treatment and has a preferred specific gravity in the range of about 0.005-0.06. Most commercial foam in use has specific gravity are in the range 0.02-0.035. The volume of damper inside cavity is 0.4%-20%, while the thickness of foam is 30 mm.

For the present invention, it is recommended that a pressure-sensitive transfer adhesive be employed on the foam roll.

The installation of the noise damper is done in a known, conventional manner. For example, a tire can be built in such a way that the noise damper portion where the foam was attached was free of mold release. For example, U.S. Pat. Nos. 7,332,047; 7,419,557; 8,776,851; and 9,630,457, all issued to Majumdar et al., the disclosure of which is incorporated herein by reference, teaches a thermoformable barrier film based on nylon or a film based on a blend nylon and rubber commonly referred to a dynamically vulcanized alloy (DVA).

A barrier film was employed in the '047 patent, wherein a removable “self-supporting barrier film of non-sulfur vulcanizable, expandable, thermoformable synthetic resinous material” is applied to the inner-surface of the tire, followed by mold release application, and curing to prevent release agents from contaminating the inner surface of the tire where foam will be adhered. After tire cure, the barrier film is removed and the foam is attached on the clean innerliner surface.

There are three basic ways that a tire with noise-cancelling foam can be manufactured:

Method 1: Apply a thin layer of foam precursor inside green (uncured) tire. During tire cure conditions (160° C./200 psi) foam is formed from the precursor when the tire comes out of the mold. This eliminates extra steps of applying foam to cured tire. Some patent literature exists but the process is far from commercialization.

Method 2: Apply cured foam inside green tire and then cure the composite at high temperature and pressure. It eliminates many post-cure tire application steps and at least one piece of patent literature exists.

Method 3: Apply cured foam to cured tire. Take cured foam and adhered to cured tire. Presently, all commercial tires with foam are made this way.

### Best Way to Carry Out the Invention

Select an acoustic foam 10 of appropriate thickness (for example, polyether polyurethane of density 0.03 g/cm³ and a thickness of 25 mm) with tapered ends (as in FIG. 2), the longer side 19 of which is coated with pressure sensitive adhesive 20 through a foam converter. The terminal ends are cut to provide tapered ends 14, 16. The pressure sensitive adhesive 20 is protected with a release coated paper 21 which will be removed just before application to tire. Cut the foam with adhesive to appropriate width e.g. 9 cm wide and the ends at an angle of about 20°. The length of the foam should be longer than the internal circumference of the tire where it will be applied. This may also be done by foam converter. The inside of the tire innerliner should be clean and free of mold release and the foam noise damper is attach inside the tire with gradual removal of the protective release paper overlapping the foam splice and joined by the adhesive present underneath the foam. The foam noise damper can be applied as a one-piece foam or multiple pieces or sections of foam as shown in FIGS. 4-6.

### Alternative Way to Carry Out the Invention

A foam without the pressure-sensitive adhesive coat underneath can be employed. An adhesive which is not a pressure sensitive type is applied underneath the foam and then the foam is applied inside the tire with the adhesive touching the tire innerliner and the overlapped portion of the splice. The adhesive can cover the entire surface of foam or partially cover the surface in strip form to save some adhesive. The adhesive will solidify and attach the foam to the inner tire. This process can be slightly modified by applying adhesive inside the tire first and then applying the foam inside. In this case, some smearing of adhesive in the overlapped area is needed.

Most adhesives will require a tire with clean innerliner where the noise damper will be applied. However, some silicone adhesives are known which bond strongly to tire noise damper without cleaning of mold release e.g. Loctite Silicone 5900 or Loctite Silicone 5910. (See, U.S. Pat. No. 7,368,024 to Majumdar et al. or US Pub. No. 2013/0032262 to Bormann et al.).

In commercial tires with foam, splice of foam is cut at an angle of 90° and joined by an adhesive. The foam must be of exact length as inner circumference of the tire with very little margin of error. If the foam is cut slightly shorter than the inner circumference of the tire, scrap foam will be generated, resulting in waste. With the present invention, there is a greater margin of error, and less scrap is produced. In the present invention, if the cut is at an angle of less than 90°, preferably at a 45° angle. Other angles are possible, such as 5 to 65 degrees, 10 to 40 degrees, or 40 to 50 degrees. 15 degrees is also a preferred angle.

In all commercial tires with foam, splices were joined using an adhesive which is an extra manufacturing step if splice is not joined as in U.S. Pat. No. 7,669,628. Little gaps between the foam significantly impairs sound absorption, leading to increased cabin noise. When splice of foam is cut at an angle of 45°, less impairment of sound absorption takes place and decreased cabin noise compared to splices where the ends are cut at an angle of 90° (vide infra).

### EXAMPLE

Four identical sets of tires were manufactured where innerliner was kept clean as in U.S. Pat. No. 7,332,047. Adhesive coated foam were inserted in the same manner with the only difference being that for a first set, the foam was cut at 90° and the terminal ends left unjoined with a little gap, the next or second set was made using a foam where the terminal ends were cut at 45° and the terminal ends were left unjoined with a little gap. The third set of tires were made using a foam where terminal ends were cut at 90° and the terminal ends were adhesively joined (as represented in the prior art), and the fourth set was made using foam where the terminal ends were cut at 45° and the terminal ends overlapped and joined by the pressure sensitive adhesive present between the top of the one terminal end of the foam and underneath the overlapped terminal end of the foam. Experimental tires were mounted on a vehicle and the noise reduction was measured at the left ear of the driver's side of the vehicle cabin in an anechoic chamber and the results were as follows:

Noise reduction (decibels, dBa)

| | |
|---|---|
| Small gap between foam and ends cut at 90° | −0.64 |
| Small gap between terminal ends cut at 45° | −1.33 |
| Terminal ends cut at 90°angle, and splice joined by an | −2.47 |
| adhesive | |
| Terminal ends cut at 45°, overlapped, and the overlapped | −2.69 |
| terminal end joined by an adhesive present on the other | |
| terminal end (Present Invention) | |

As the table shows, the present invention yielded the best results.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated.

What we claim is:

1. A tire comprising:
a circumferential tread having an outer tread surface and an inner innerliner surface;
at least two spaced-apart beads;
sidewall portions extending between the tread and the beads; and
a belt-like foam noise damper having first and second terminal ends, wherein the noise damper lines said innerliner surface; wherein the noise damper is adhesively secured to said innerliner surface, and wherein the terminal ends of said noise damper are cut at an angle of less than 90 degrees, overlap each other, and the overlapped second terminal end of the foam is joined to the first terminal end by the adhesive present underneath the second terminal end.

2. The tire of claim 1 wherein the terminal ends are cut at an angle of between about 5 degrees and about 65 degrees.

3. The tire of claim 1 wherein the terminal ends are cut at an angle of between about 10 degrees and 55 degrees.

4. The tire of claim 1 wherein the terminal ends are cut at an angle of about 40 degrees to 50 degrees.

5. The tire of claim 1 wherein the terminal ends are cut at an angle of about 45 degrees.

6. The tire of claim 1 wherein the terminal ends are cut at the same angle.

7. The tire of claim 1 wherein the terminal ends are cut at different angles.

8. A method for making a tire having a foam noise damper, the method comprising the steps of:
A. pressing a barrier layer onto an exposed virgin surface of a green tire innerliner to adhere the barrier layer to the virgin surface and thereby form a protected green innerliner;
B. applying a mold release agent inside the tire;
C. curing the tire with protected innerliner;
D. removing the barrier layer to reveal the tire innerliner virgin surface; and
E. securing a foam noise damper having a short side and a longer side coated with adhesive on the longer side to the virgin surface where at least the one end of the foam is cut at an angle to 45 degrees and overlaps the other end of the foam cut at an angle of approximately 45°.

9. A method for making a pneumatic tire having a foam noise damper, comprising the steps of:
A. providing a pneumatic tire comprising two spaced inextensible beads; a ground contacting tread portion; a pair of individual sidewalls extending radially inward from the axial outer edges of said tread portion to join the respective beads, the axial outer edges of the tread portion defining a tread width, a supporting carcass for tread portion and sidewalls, an innermost innerliner surface;
B. installing a trapezoid shaped noise damper disposed radially inward of the carcass, the noise damper having a shorter surface facing an interior cavity of the tire;
C applying a silicone adhesive to the noise damper surface having higher surface area to form an adhesive prepared surface;
D. applying a solid foam noise reducer having ends to the tire innerliner surface where at least one end of the foam is cut at an angle to 45° and overlaps the other end of the foam cut at an angle of approximately 45°; and
E. curing the adhesive.

10. The method of claim 9 wherein the tire innerliner surface includes a mold release agent where the noise damper is attached.
